(19) United States
(12) Patent Application Publication
(10) Pub. No.: US 2017/0287328 A1
(43) Pub. Date: Oct. 5, 2017

(54) Traffic Data Encoding Using Fixed References

(71) Applicant: Sirius XM Radio Inc., New York, NY (US)

(72) Inventor: Leslie John French, Princeton, NJ (US)

(21) Appl. No.: 15/473,113

(22) Filed: Mar. 29, 2017

Related U.S. Application Data
(60) Provisional application No. 62/314,630, filed on Mar. 29, 2016.

(51) Int. Cl. G08G 1/09; G08G 1/0967

(52) U.S. Cl. CPC G08G 1/092; G08G 1/091; G08G 1/096791

(57) ABSTRACT

A method is provided for encoding traffic incident and flow data using target map locations, such as OpenStreetMap (OSM) locations directly, rather than going through a conversion stage. In exemplary embodiments, the method can include selecting a set of fixed, identifiable locations along a roadbed, matching these to a target map, generating flow vectors in the target map's referencing model, and deliver only target map location data to the external application. Non-point location data such as incidents can also be represented using the same scheme, using an offset along a previously defined path for the start and end points.

### CROSS-REFERENCE TO RELATED APPLICATION

This application claims the benefit of U.S. Provisional Application No. 62/314,630, filed on Mar. 29, 2016, the contents of which are incorporated herein by reference in their entireties.

### TECHNICAL FIELD

The present subject matter relates to traffic data processing, and in particular, to encoding and distributing traffic incident and flow data.

### BACKGROUND

Various proposals have been presented for improving the accuracy of traffic information broadcast over a communications channel. For example, the currently accepted Radio Data System/Traffic Message Channel (RDS/TMC) standard uses a coding method called Alert-C which allocates identifiers to fixed points on the ground and to the segments of roadway that run between those points.

An alternative standard, called the Transport Protocol Experts Group (TPEG), supports the TMC model and also arbitrary points identified by geographic (longitude/latitude) coordinates or by free text that can be used in conjunction with a mapping database (e.g., “W 54^{th} St, New York”).

An additional proposal has been made where the Alert-C format is enhanced by means of a “Precise Location Reference (PLR)” which indicates a point, and an extent from that point, in distance units (e.g., yards or miles) from one of the pre-defined location points.

Both TPEG and PLR suffer from a number of disadvantages when applied to a broadcast distribution medium such as a satellite radio channel.

More recently, TomTom International launched an open source software project called OpenLR that provides “procedures and formats for the encoding, transmission, and decoding of local data irrespective of the map.” The format allows locations localized on one map to be found on another map to which the data have been transferred. OpenLR requires, however, that the coordinates be specified in the World Geodetic System (WGS) 84 format and that route links are given in meters. Also, all routes need to be assigned to a “functional road class.” Details of OpenLR are provided at http://www.tomtom.com/page/openLR.

Because OpenLR enables local data to be encoded, transmitted, and decoded irrespective of the map, it enables the use of a map source like the OpenStreetMap (OSM), which is a collaborative project to create a free editable map of the world. Two major driving forces behind the establishment and growth of OSM have been restrictions on use or availability of map information across much of the world and the advent of inexpensive portable satellite navigation devices. OSM is considered a prominent example of volunteered geographic information.

As will be described in more detail below, the OpenLR conversion process can produce inconsistent results and errors. To overcome these and other problems, the present subject matter provides, among other benefits and solutions, a way to use location data (such as OSM, for example) directly in traffic data reporting systems, without having to perform an additional conversion stage as required by current methods such as OpenLR.

### BRIEF DESCRIPTION OF THE DRAWINGS

FIG. 1 is a block diagram illustration of an exemplary traffic reporting and encoding system in accordance with some embodiments of the present subject matter;

FIG. 2 is a graphical illustration of an exemplary stretch of road represented using different map references;

FIG. 3 is a process flow diagram of a conversion process; and

FIG. 4 is a process flow diagram of an exemplary embodiment of the present subject matter.

### DETAILED DESCRIPTION

This application includes improvements upon the inventor's prior patent application PCT/US2014/029221, published as WO 2014/153130, and its continuation-in-part U.S. patent application Ser. No. 14/852,608, filed on Sep. 15, 2015. The contents of both applications are incorporated herein by reference in their entireties.

The present subject matter provides a system and method for distributing traffic incident and flow data using locations of the target map database directly, rather than going through an conversion stage required by existing methods like the OpenLR.

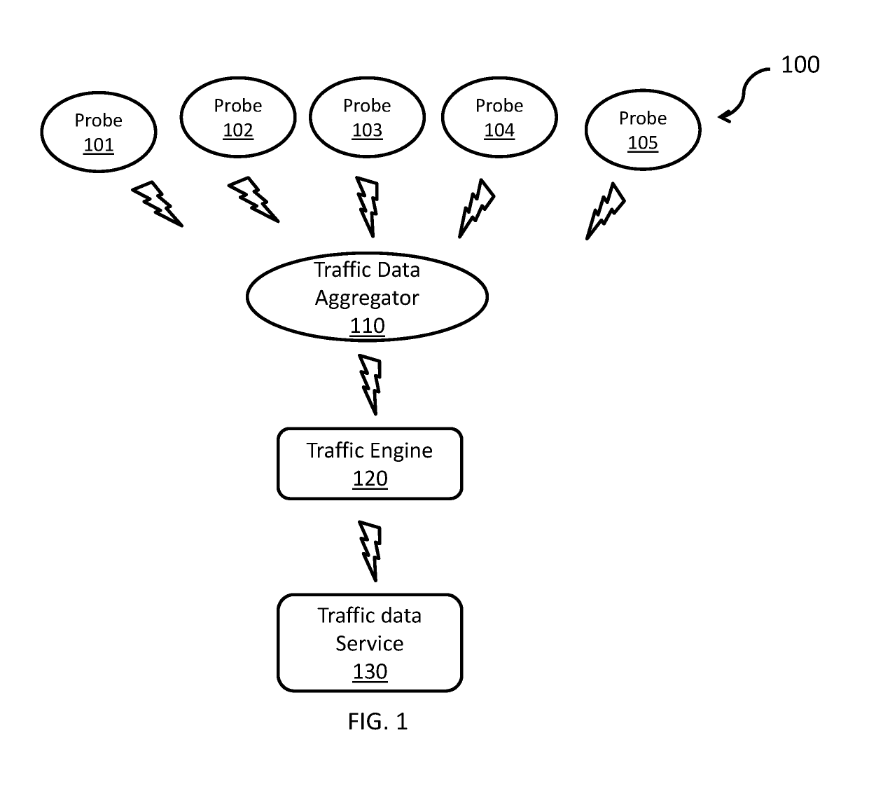

FIG. 1 depicts a traffic data system in accordance with some embodiments of the present subject matter. Traffic data system 100 includes a plurality of probes (101-105) that are attached to respective vehicles, and are configured to gather and transmit vehicle data (e.g., vehicle telematics) from the respective vehicles to traffic data aggregator 110 via data connections (e.g., cellular and other wireless data networks) as, for example, known in the art. The vehicle telematics can include one or more vehicle data such as speed, location, and GPS data.

Traffic data system 100 also includes traffic engine 120, which is in data communication (e.g., via a wireless or wired data connection) with traffic data aggregator 110 to receive the vehicle data aggregated by the traffic data aggregator. Based on the aggregated vehicle data, traffic engine 120 can determine traffic data including one or more of, for example, speed, flow, incident, and other traffic information of various roads. In some embodiments, the traffic engine 120 is the Exclusive Traffic Engine (ETE) developed by TrafficCast International (TCI). In some embodiments, the traffic engine 120 can be implemented as a cloud service.

As shown, traffic engine 120 is in data communication (e.g., via a wireless or wired data connection) with traffic data service 130 to encode and transmit the traffic data to one or more receivers. In some embodiments, traffic engine 120 includes a traffic modeling system that can generate a traffic model based on, for example, past and/or current traffic data. The traffic modeling system can, in some embodiments, be configured to predict traffic based on past and/or current traffic data. In some embodiments, the traffic data service 130 can be the Apogee traffic service offered by SiriusXM, for example, as described in the Inventor's earlier patent applications noted above. Once received, each receiver decodes the received encoded traffic data to display relevant traffic information to a user. In some embodiments, one or more of the receivers are part of a vehicle infotainment system. In some embodiments, one or more of the receivers are part of a navigation system.

In some embodiments, the receivers utilize an open-source map, such as OpenStreetMap (OSM). Although the features of the present subject matter are being discussed with respect to OSM (and other standards and services), these are merely being used for illustrative purposes; one skilled in the art would recognize that the present subject matter can be applied for use with other maps, standards, and/or services in accordance with some embodiments of the present subject matter.

OpenStreetMap uses a topological data structure, with four core elements (also known as data primitives): Nodes, Ways, Relations, and Tags.

Nodes are points with a geographic position, stored as coordinates (pairs of a latitude and a longitude) according to WGS 84. Outside of their usage in ways, they are used to represent map features without a size, such as points of interest or mountain peaks.

Ways are ordered lists of nodes, representing a polyline, or possibly a polygon if they form a closed loop. They are used both for representing linear features such as streets and rivers, and areas, like forests, parks, parking areas and lakes.

Relations are ordered lists of nodes, ways and relations (together called “members”), where each member can optionally have a “role” (a string). Relations are used for representing the relationship of existing nodes and ways. Examples include turn restrictions on roads, routes that span several existing ways (for instance, a long-distance motorway), and areas with holes.

Tags are key-value pairs (both arbitrary strings). They are used to store metadata about the map objects (such as their type, name and physical properties). Tags are not free-standing, but are always attached to an object: to a node, a way, or a relation.

The OpenStreetMap data representation thus includes three XML elements:

<node> defines a point location by longitude and latitude;

<way> defines a linear element as a sequence of nodes; and

<relation> links nodes, ways and relations into more complex higher-level structures.

The elements have attributes and content elements. Metadata are held in <tag> content-elements as keyword-value pairs, such as, for example:

<tag k=“ref” v=“I 78”/>

indicating that one label used to refer to that <way> is “I 78.” Using <tag> elements with k and v attributes means that the core XML schema does not need to be modified as new attributes are defined, which would not be the case if the representation was: <ref>I 78 </ref>

All instances of the three basic OSM elements have immutable IDs, within their type, once assigned. Notionally, the OSM database is a single coherent XML tree usually called planet.osm. This can be extracted into country-level, state-level or any other boundary subsets, and there are a variety of tools in the public domain (generally implemented in the JAVA programming language), the main one being osmosis. There are also companies that offer the extraction process as a service, as well as converting OSM files to other representations, for example, ArcInfo projects.

The OSM files can be quite large. For example, the New Jersey component alone is about 1.3 Gbytes, uncompressed XML. Almost the entire file consists of <node> entries. There are about 6,055,000 Nodes in New Jersey, 454,000 Ways and 9,500 Relations.

Taking highway US-1 as an example:

Relation #112245 defines the whole of the US-1 super-linear, from Florida to Maine. The contents of this Relation also include other Relations including, for example, Relation #946435 which defines US-1 within New Jersey. Relation #946435 is defined as a sequence of 482 individual Ways.

From this, one may, for example, find all the Ways that comprise US-1 between I-95 near Princeton, N.J. and Adams Lane near New Brunswick. This reveals one of the problems with OSM, that there are many inconsistencies in the data, reflecting its update process by a mass of contributors with no coordination. Consequently, there are missing <way> identifiers in the US-1 list, that show up as gaps in the coverage, likely caused by one user subdividing existing Ways without updating (or possibly being unaware of) the higher-level relation. For example, there is no northbound coverage from the entrance of the Extended Stay hotel just past Nassau Park Boulevard all the way to Carnegie Center Boulevard.

Way #116629270 runs northbound from the QuakerBridge Mall ramp over US-1 to the Extended Stay Hotel. The endpoint is Node #3489321557 at -74.671134, 40.30411. That Node does not appear in any of the other Ways listed as part of US-1 in #94635. The Node does exist in other Ways. It is one end of Way #341885304, also labelled as US-1, which links to Way #341885306, then to #341885305, to #341885307 and then to #341886963, which ends at Node #299850354 which is the start of Way #61157240 which is listed as part of US-1.

In exemplary embodiments, the present subject matter generates a sequence of Way numbers representing the path of US-1, in both directions (they have separate Ways). Because intersections must be represented by Nodes, there are Node points at all the places where a location might be required (and there is always the option for precise location referencing using offsets).

A stretch of roadway can be identified simply by its Way number, or for example, by a start and end point within one or more Ways. For example, US-1 from the exit ramp at QuakerBridge Road to the traffic light at Carnegie Center Boulevard can be represented as: from Node #764861380 in Way #116629270 to Node #299850365 at the junction of Way #61157258 and Way #61157252.

Specifying the Way number ensures that the correct road path is used. The stretch of US-1 from Carnegie Center Boulevard to Washington Road is simply Way #61157252.

On the traffic side, any application such as a routing system that wishes to make use of traffic flow and incident data, as opposed to simply overlaying a graphic on a base map, will need to match those data to its map layer. This is equally true of traffic modelling systems (implemented, for example, as part of the traffic engine) such as the Exclusive Traffic Engine (ETE) developed by TrafficCast International (TCI), for example, which must map-match probe data to links within a map database, and generate flow values for those links using the traffic model. The ETE also aggregates link-based flow values into longer map segments, including but not limited to those sequences of map links that represent road linears and segments thereof within the TMC location referencing framework.

In exemplary embodiments of the present application, systems and methods satisfying the following assumptions may be used.

1. An application (“app”) is developed that uses OSM as its base geospatial layer.

2. Neither the application, nor any back-end system outside flow modelling system (e.g., ETE by TCI) has access to the TMC consortium tables, or will license commercial maps to deliver data to individual apps.

3. Speed, flow, and incident data are processed by systems outside TCI and will deliver the data in some form to apps, possibly as map overlays, possibly as speed and flow data directly, possibly as route-based metadata associated with OSM links or accompanying a graphic overlay.

Under assumption 2, the processing system will be unable to use any of the current TCI feeds because they are all based on TMC location references, but OpenLR referencing can be used instead.

As noted above, OpenLR is a standard for “procedures and formats for the encoding, transmission, and decoding of local data irrespective of the map” developed by TomTom. OpenLR requires, however, that coordinates be specified in the WGS 84 format and that route links are given in meters. Also, all routes need to be assigned to a “functional road class.”

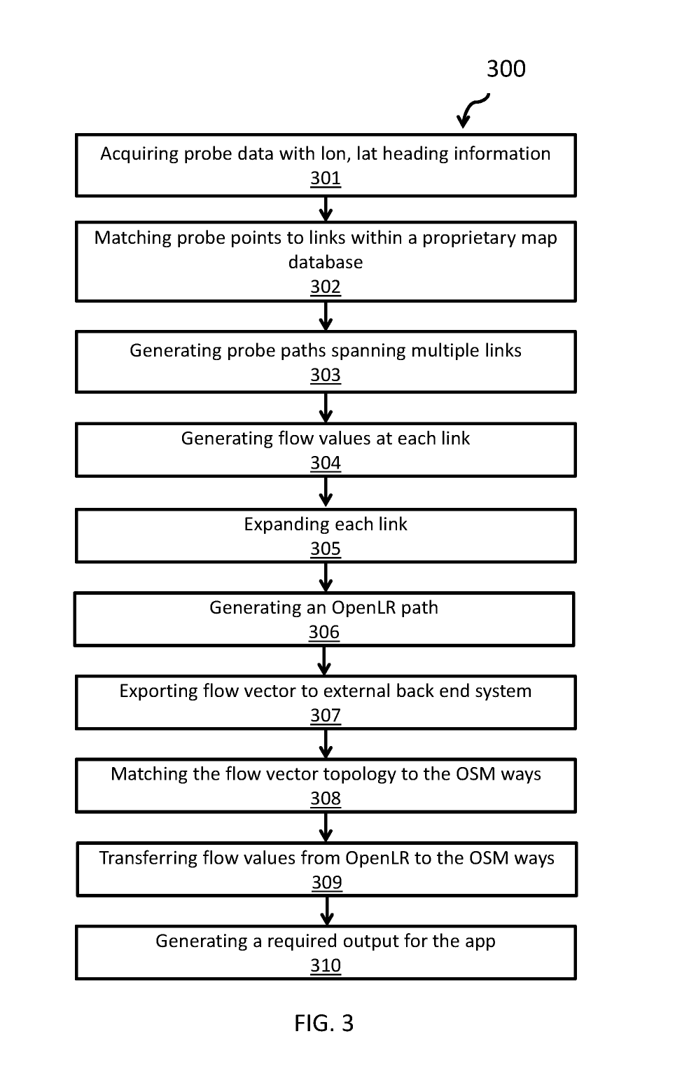

A problem with OpenLR is that OpenLR appears to add an unnecessary and error-inducing step into its conversion process. As illustrated in FIG. 3, the OpenLR process 300 would require the following steps [similarly for flow and incident encoding]: At 301, probe data are acquired with longitude and latitude (long, lat) heading information. At 302, probe points are matched to links within a proprietary map database such as those sold by Here or TomTom. At 303, map topology is used to generate Probe paths spanning multiple links. At 304, the ETE uses the probe paths to generate flow values (speed and congestion) at each link. At 305, each link (or short sequence of links) is expanded to its list of internal longitude and latitude values. At 306, an OpenLR path is generated from those points (because they must contain the full topology of the path), and flow values are associated with distances along the path [e.g., using a flow-vector model such as the TPEG Flow Vector]. At 307, the Flow Vector is exported to an external back-end system. At 308, the Flow Vector topology is map-matched, point-by-point, to the OSM map Ways. At 309, the flow values from the OpenLR vector are transferred to the OSM Ways. At 310, way data are aggregated and processed to generate the required output for the app, such as routing and travel-time estimates. If the app is also to receive OpenLR referencing, any OSM-based flow vectors must then be converted back into OpenLR coordinates sequences.

There is the possibility that the map-matching performed at 308 may not generate the same path that was used at 304, especially if the map coordinates are different for the same physical roadbed (as they will be). The process would be much improved if the OSM data were delivered directly at 307.

Both proprietary and open-source maps are representing the same physical underlying road structure, and both have metadata that can be used to identify common locations (for example “US-1 at Washington”) even if the geo-coordinates differ slightly. Using common physical points leads to approach illustrated in FIG. 1.

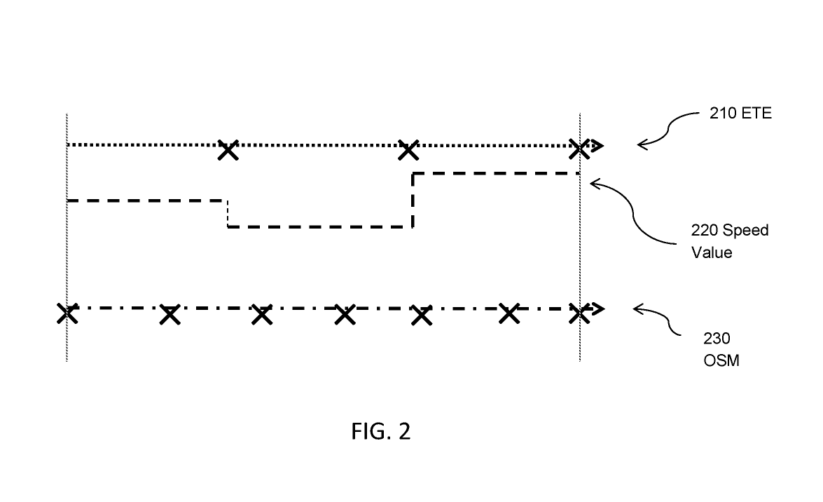

FIG. 2 is a graphical illustration of an exemplary stretch of road represented in two different ways. The upper line 210 shows the map topology as might be used in a traffic modelling system such as the Exclusive Traffic Engine (“ETE”) developed by Traffic Cast (“TCI”), where each X represents the end of a map link. The lower line 230 shows the same physical roadbed as represented in an open-source map database such as the OSM database, where each X represents a Node in a Way that is part of that road. The middle line 120 is a model output showing the speed value assigned to each link. In exemplary embodiments of the present application, it is assumed that a set of points are chosen on the roadbed representing easily-identified physical locations (such as intersections) and that the physical location has a representation in both map systems.

As an example, in the current TCI output formats, the whole of the line 210 could be represented by a Flow Vector of the form (as an example): 40:33, 30:66, 55 which represents 40 mph for the first ⅓ of the Vector, 30 mph for the next ⅓ (i.e., up to 66%) and then 55 mph for the remainder. The identification of the roadbed is currently through a TMC location reference.

The same scheme would work equally well for the line 230, for example, as:

from [Node₁ in Way₁] to [Node₂ in Way₂]: 40:33, 30:66, 55

In this method, the common data are the longitudinal and latitudinal points of the physical feature on the roadbed. That point remains at the same location even when both sides of the map referencing scheme are mutable. For example, the sequence of Way and Node values will change in OSM if Ways are subdivided to add more entrance or exit points, or side roads. In other words, by using fixed locations that are immutable (such as intersections that are unlikely to change), intermediate points in the segments between those locations can be translated or approximated in the flow vector, for example, as a percentage of the respective segment, rather matching them point-by-point. This improves the conversion process by reducing the potential error caused, for example, by mismatches between the maps, and increases efficiency.

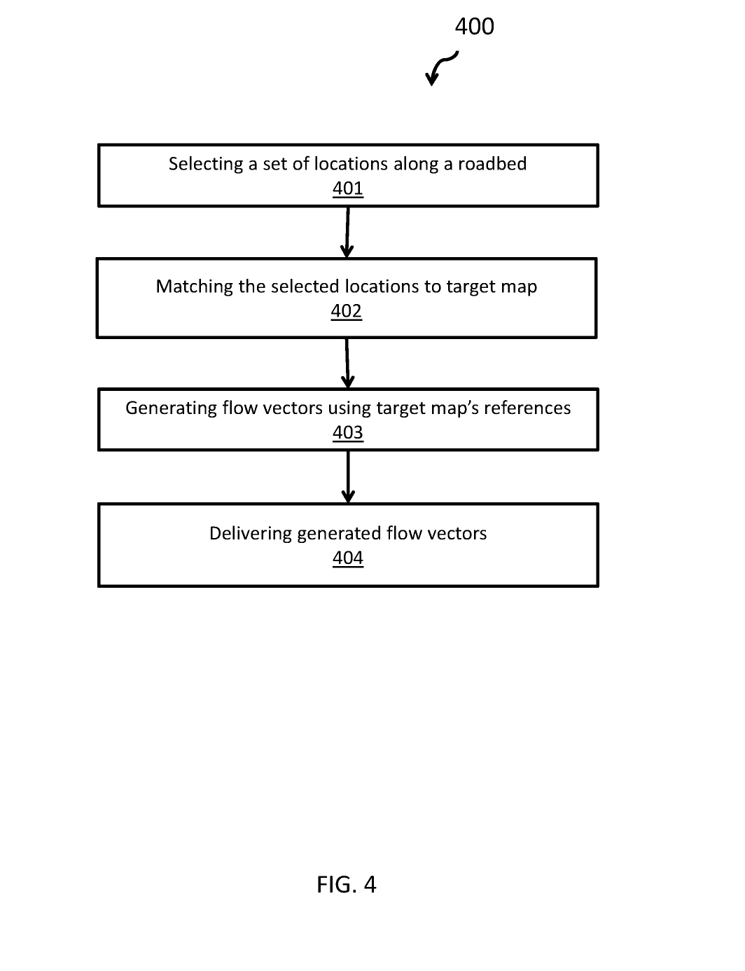

FIG. 4 illustrates a traffic encoding method 400 in accordance with an exemplary embodiment of the present application. As shown, the method includes selecting a set of fixed, identifiable locations along a roadbed at 401. At 402, the method matches those locations to the corresponding locations of the map (target map) used by a target device (e.g., an infotainment receiver of a vehicle). In some embodiments, the map is OpenStreetMap (OSM), and those locations are matched to the corresponding map references (e.g., Nodes and Ways). At 403, the method includes generating one or more flow vectors using the references of the target map. For example, when OSM is used, the flow vectors can be generated in a ‘pure’ OSM referencing mode. In some embodiments, the flow vectors are generated directly into the locations of the target map without going through one or more intermediate location translation (e.g., a point-by-point matching). At 404, the method includes delivering the generated flow vectors to the target device to be processed by the target device to display traffic data using the target map (e.g., OSM).

In some embodiments, the traffic encoding method 400 can be implemented by the traffic data service 130 to provide a more efficient encoding of traffic data that can avoid mismatches and errors, particularly when there are discrepancies in some of the coordinates between different map database.

In some embodiments, the traffic engine receives one or more incident reports from an incident report service. The incident reports can include non-point-location incidents that can also be represented using the same scheme, using an offset along a previously-defined path for the start and end points.

Unlike OpenLR, in exemplary embodiments of the present application, there is no need to specify the road topology between the node points, or try to identify the road by name. Unlike TMC, such exemplary embodiments do not require additional tables at the receiving end because the data are directly in the target map values (e.g., OSM map values), and each flow vector is self-defining by its starting and ending immutable map reference.

For example, because the OSM references are immutable, as long as one chooses sufficiently stable physical points, the OSM side will change infrequently, if at all, and the referencing scheme is independent of any Way or Node change within the path as new versions of the OSM map are generated (as frequently as is warranted).

Similarly, no vendor-specific map identifiers, or topologies, are exposed. All that is required at the generating end is that longitudinal and latitudinal values are mapped to link points, and that paths are constructed along links, the same operations that are currently performed for probe data matching.

The step of generating flow vector using target map's references (e.g., using OSM references) can be, in some embodiments, completely independent of any of the processing performed on the flow data that might be associated with other location referencing schemes (including OpenLR, if that had to be done for another reason).

In one exemplary implementation, a traffic data service provider such as SiriusXM and a third party back-end supplier can jointly determine the coverage of the service, and select a set of reference nodes (e.g., OSM nodes) that represents that coverage. A traffic modeling system (e.g., ETE by TCI) maps the selected reference nodes (e.g., OSM nodes: lon, lat on road) to their internal map links. The model portion of the ETE is unchanged. An additional output generator at the traffic modelling system (e.g., ETE by TCI) produces output files matching the map paths (e.g., OSM paths). The third party back-end ingests these files and processes them using their OSM map data.

The systems described herein, or portions thereof, can be implemented as a computer program product or service that includes instructions that are stored on one or more non-transitory machine-readable storage media, and that are executable on one or more processing devices to perform or control the operations described herein. The systems described herein, or portions thereof, can be implemented as an apparatus, method, or electronic system that can include one or more processing devices, parallel processing devices, and memory to store executable instructions to implement various operations.

It should be understood that the aspects, features and advantages made apparent from the foregoing are efficiently attained and, since certain changes may be made in the disclosed inventive embodiments without departing from the spirit and scope of the invention, it is intended that all matter contained herein shall be interpreted as illustrative and not in a limiting sense.

### Exemplary Systems

In exemplary embodiments of the present invention, any suitable programming language can be used to implement the routines of particular embodiments including C, C++, Java, JavaScript, Python, Ruby, CoffeeScript, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage device or non-transitory computer readable medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

Particular embodiments may, as noted, be implemented in an SDARS receiver in a vehicle, in combination with UWB equipment. Other components are fixed UWB master and slave sites provided in a geographical area, where the master site has at least one of a SDARS receiver and a GPS receiver, and a slave site may have one or both of those, but need not. Such equipment may include hardware, software, middleware and firmware, as maybe appropriate.

It will also be appreciated that one or more of the elements depicted in the drawings can also be implemented in a more separated or integrated manner, or even removed or rendered as inoperable in certain cases, as is useful in accordance with a particular application. It is also within the spirit and scope to implement a program or code that can be stored in a machine-readable medium, such as a storage device, to permit a computer to perform any of the methods described above.

As used in the description herein and throughout any claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Although various methods, systems, and techniques have been described herein, the scope of coverage of this disclosure is not limited thereto. To the contrary, this patent is understood to cover all methods, systems, and articles of manufacture fairly falling within the scope of this disclosure.

1. A computer-implemented method of encoding traffic data, the method comprising:
at a computing device having a data processor and computer memory:
matching a set of fixed locations along a roadbed to a target map;
generating flow vectors representing traffic data using the fixed locations of the target map; and;
delivering the generated flow vectors to a receiver to enable the receiver to render the represented traffic data based on the generated flow vectors.

2. A computer-implemented method according to claim 1, further comprising receiving vehicle telematics data from a plurality of probes, and aggregating the received vehicle telematics data to generate current traffic data.

3. A computer-implemented method according to claim 2, wherein the traffic data is generated based at least in part on a traffic model and the current traffic data.

4. A computer-implemented method according to claim 1, wherein the traffic data is generated based at least in part on a traffic model.

5. A computer-implemented method according to claim 1, wherein the generating of flow vectors include translating coordinates of intermediate points between the fixed locations as vectors with respect to the fixed locations.

6. A computer-implemented method according to claim 1, wherein the target map is OpenStreetMap (OSM).

7. A computer-implemented method according to claim 6, wherein the fixed locations are represented using Nodes and Ways.

8. A computer-implemented method according to claim 1, wherein the set of locations are intersections.

9. A traffic encoding system comprising:
a processor; a memory coupled to the processor; and a program stored in the memory, the program including instructions for:
matching a set of fixed locations along a roadbed to a target map;
generating flow vectors representing traffic data using the fixed locations of the target map; and;
delivering the generated flow vectors to a receiver to enable the receiver to render the represented traffic data based on the generated flow vectors.

10. A traffic encoding system according to claim 9, wherein the instructions further comprises receiving vehicle telematics data from a plurality of probes, and aggregating the received vehicle telematics data to generate current traffic data.

11. A traffic encoding system according to claim 10, wherein the traffic data is generated based at least in part on a traffic model and the current traffic data.

12. A traffic encoding system according to claim 11, wherein the traffic data is generated based at least in part on a traffic model.

13. A traffic encoding system according to claim 9, wherein the generating of flow vectors include translating coordinates of intermediate points between the fixed locations as vectors with respect to the fixed locations.

14. A traffic encoding system according to claim 9, wherein the target map is OpenStreetMap (OSM).

15. A traffic encoding system according to claim 14, wherein the fixed locations are represented using Nodes and Ways.

16. A traffic encoding system according to claim 9, wherein the fixed locations are intersections.

17. A non-transitory computer-readable storage medium storing one or more programs, the one or more programs comprising instructions that, when executed by a data processor, causes the data processor to:
match a set of fixed locations along a roadbed to a target map;
generate flow vectors representing traffic data using the fixed locations of the target map; and;
deliver the generated flow vectors to a receiver to enable the receiver to render the represented traffic data based on the generated flow vectors.

18. A non-transitory computer-readable storage medium according to claim 17, wherein the instructions further causes the data processor to receive vehicle telematics data from a plurality of probes, and aggregating the received vehicle telematics data to generate current traffic data.

19. A non-transitory computer-readable storage medium according to claim 17, wherein the traffic data is generated based at least in part on a traffic model and the current traffic data.

20. A non-transitory computer-readable storage medium according to claim 17, wherein the traffic data is generated based at least in part on a traffic model.

21. A non-transitory computer-readable storage medium according to claim 17, wherein the generating of flow vectors include translating coordinates of intermediate points between the fixed locations as vectors with respect to the fixed locations.

22. A non-transitory computer-readable storage medium according to claim 17, wherein the target map is OpenStreetMap (OSM).

23. A non-transitory computer-readable storage medium according to claim 22, wherein the fixed locations are represented using Nodes and Ways.

24. A non-transitory computer-readable storage medium according to claim 17, wherein the fixed locations are intersections.
